(19) United States
(12) Patent Application Publication
(10) Pub. No.: US 2024/0370893 A1
(43) Pub. Date: Nov. 7, 2024

(54) Methods and Systems for Verifying Promotional Challenges and Claiming Rewards

(71) Applicant: T-Mobile Innovations LLC, Overland Park, KS (US)

(72) Inventor: Andiputranto Sukojo, Sammamish, WA (US)

(21) Appl. No.: 18/313,311

(22) Filed: May 5, 2023

(51) Int. Cl. G06Q 30/0208; G06Q 30/0207; H04W 4/029

(52) U.S. Cl. CPC G06Q 30/0208; G06Q 30/0225; H04W 4/029

(57) ABSTRACT

A method performed by a challenge and reward system comprises obtaining a challenge to offer a user and one or more rewards associated with completing the challenge, wherein the challenge indicates one or more tasks that are to be completed by the user to claim the one or more rewards, transmitting, to the UE, an options message comprising data describing the challenge, the one or more rewards, verification requirements for the challenge, and access requirements for the challenge, determining, using a machine learning model, a confidence score of the verification data, wherein the confidence score represents a likelihood that the user successfully completed the challenge, and transmitting a code to the UE to claim one of the rewards in response to the confidence score exceeding a threshold value.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A challenge and reward promotional system is a marketing strategy that incentivizes customers to engage with a business by completing specific tasks or challenges in exchange for rewards. The challenges may be simple, such as signing up for a newsletter, following the business on social media, or referring friends, or they may be more complex, such as completing a survey or making a purchase. The rewards may vary depending on the difficulty of the challenge, but they typically include discounts, free products or services, or entries into sweepstakes or contests.

The challenge and reward promotional system is a popular strategy for businesses that want to increase customer engagement and loyalty. By offering rewards for completing challenges, businesses can incentivize customers to take specific actions that help them achieve their goals. Additionally, the system can help businesses gather customer data and insights, such as preferences, behaviors, and demographics, which can be used to improve their marketing campaigns and product offerings.

### SUMMARY

In an embodiment, a method performed by a challenge and reward system is disclosed. The method includes transmitting, by a challenge application of a server to a user equipment (UE) of a user, an options message comprising data describing a challenge offered to a user and associated verification requirements, access requirements, and a plurality of rewards, receiving, by a client application of the UE, a selection of the challenge and one of the rewards, and obtaining, by the client application, verification data used to prove completion of the challenge in response to receiving the selection of the challenge and the one of the rewards. The verification data comprises at least one of Global Positioning System (GPS) data, pictures, videos, smart watch data, connected device data, user data, or social media data. The method further includes transmitting, by the client application, the verification data to the server to verify completion of the challenge, determining, by a verification application of the server using a machine learning model, a confidence score of the verification data, and transmitting, by a reward application of the server, a code to the UE to claim the one of the rewards in response to the confidence score exceeding a threshold value. The confidence score represents a likelihood that the user successfully completed the challenge.

In another method, a method performed by a challenge and reward system is disclosed. The method includes obtaining, by a challenge application of a server, a challenge to offer a user and one or more rewards associated with completing the challenge, the challenge indicating one or more tasks that are to be completed by the user to claim the one or more rewards. The method further includes transmitting, by the challenge application to a user equipment (UE) of the user, an options message comprising data describing the challenge, the one or more rewards, verification requirements for the challenge, and access requirements for the challenge, receiving, by a verification application of the server, from the UE, verification data used to prove completion of the challenge, determining, by the verification application using a machine learning model, a confidence score of the verification data, and transmitting, by a reward application of the server, a code to the UE to claim one of the rewards in response to the confidence score exceeding a threshold value. The verification data comprises at least one of Global Positioning System (GPS) data, pictures, videos, smart watch data, connected device data, user data, or social media data, and the confidence score represents a likelihood that the user successfully completed the challenge.

In yet another embodiment, a system is disclosed. The system comprises a user equipment associated with a user, and a server comprising at least one processor, at least one non-transitory memory, a challenge application, a verification application, and a reward application. The challenge application, stored in the at least one non-transitory memory, which when executed by the at least one processor, causes the at least one processor to be configured to obtain a challenge to offer a user and one or more rewards associated with completing the challenge, wherein the challenge indicates one or more tasks that are to be completed by the user to claim the one or more rewards, and transmit, to the UE, an options message comprising data describing the challenge, the one or more rewards, verification requirements for the challenge, and access requirements for the challenge. The verification application, stored in the at least one non-transitory memory, which when executed by the at least one processor, causes the at least one processor to be configured to receive, from the UE, verification data used to prove completion of the challenge, wherein the verification data comprises at least one of Global Positioning System (GPS) data, pictures, videos, smart watch data, connected device data, user data, or social media data, and determine, using a machine learning model, a confidence score of the verification data, wherein the confidence score represents a likelihood that the user successfully completed the challenge. The reward application, stored in the at least one non-transitory memory, which when executed by the at least one processor, causes the at least one processor to be configured to transmit a code to the UE to claim one of the rewards in response to the confidence score exceeding a threshold value.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication system according to an embodiment of the disclosure.

FIG. 2 is a block diagram of an example method performed by the communication system of FIG. 1 according to an embodiment of the disclosure.

FIG. 3 is a block diagram of another example method performed by the communication system of FIG. 1 according to an embodiment of the disclosure.

FIG. 4 is a block diagram of yet another example method performed by the communication system of FIG. 1 according to an embodiment of the disclosure.

FIG. 5 is a flow chart of a first method performed by the system of FIG. 1 according to an embodiment of the disclosure.

FIG. 6 is a flow chart of a second method performed by the system of FIG. 1 according to an embodiment of the disclosure.

FIGS. 7A-B are block diagrams illustrating a communication system similar to the communication system of FIG. 1 according to an embodiment of the disclosure.

FIG. 8 is a block diagram of a computer system implemented within the communication system of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Companies may send promotional data or product/service data to users either sporadically or based on previously recorded user interests. The promotional data may be, for example, advertisements for products/services, postings for jobs/promotions, incentives for jobs/promotions, charity challenges, carrier network provider coverage verification requests, etc. The promotional data may indicate a reward, such as, for example, discounted products or services, career advancements, awards or accolades, etc. provided by the company. In some cases, the promotional data may indicate a challenge and reward marketing scheme, in which the user may need to complete a challenge to receive the reward. The challenge refers to one or more tasks that are to be completed by the user to claim the rewards.

The company may send the promotional data to the users, for example, in the form of one or more push messages, short message service (SMS) messages, multimedia messages (MMS), or any other type of message. A user equipment (UE) of the user may obtain the promotional data from the message and display the promotional data in the forms of, for example, advertisements, coupons, codes, or postings. The promotional data may be displayed as a standalone promotion, on a social media platform, on a webpage, or in any other form at the UE.

However, most users typically ignore these promotions, even when the user has previously expressed interest in the item being promoted. This may be because the user may not be interested in the item being promoted, that the timing of displaying the advertisement is inconvenient for the user, or that the user is busy operating the UE for other purposes and does not want to be disturbed. Therefore, companies are currently spending far too much on sending users wasted promotions that do not generate revenue. In addition, enterprise servers belonging to these companies are wasting processing resources to generate these promotions, and then wasting a large amount of network resources (e.g., bandwidth, throughput, etc.) in transmitting these undesired promotions across the network to the UEs.

The present disclosure addresses the foregoing technical problems by providing a technical solution in the technical field of data management and verification. In an embodiment, a challenge and reward system is proposed, in which the system includes an enterprise server belonging to a company (or business enterprise), a challenge and reward server, UEs, and witness UEs. The challenge and reward server may be part of the enterprise server, or the challenge and reward sever may be positioned external to the enterprise server, such that multiple enterprise servers belonging to different companies may use the same challenge and reward server. As further described herein, the challenge and reward server may gauge a user's interest in a promotion or reward prior to actually consuming processing and networking resources to transmit the reward to the user. The challenge and reward server may perform several verification steps, as further described herein, to ensure that the user has completed the challenge and is thus entitled to receive the promotion or reward. As used herein, “completion” of the challenge refers to the user performing all the tasks related to the challenge, and in some cases, providing the required proof for completing the challenge.

First, the enterprise server may determine various challenges and corresponding rewards to offer one or more users. In some cases, the enterprise server may determine challenges and rewards for a user, for example, based on user data of the user. The user data may include biographical data (age, geographical location, gender, hobbies, skills, etc.), prior accepted challenges, and prior claimed rewards. For example, the user data may indicate that a 28-year-old female has previously accepted a challenge requiring the user to purchase a pre-defined amount of different types of make-up products. The user data may also indicate that this female previously claimed a reward for discounted make-up products in response to completing the foregoing make-up purchase challenge. The enterprise server may determine additional challenges and rewards based on the prior challenge and reward information. For example, the enterprise server may determine that this user may be also interested in skin-care or hair-care purchase challenges, and similarly, that this user may be interested in rewards with free or discounted skin-care or hair-care products. The enterprise server may transmit the determined challenges and rewards for the user to the challenge and reward server.

The challenge and reward server (hereinafter referred to simply as “server”) may include a challenge application, a verification application, a reward application, and a witness application. The challenge application may obtain the challenges and rewards from the enterprise server and generate an options message. The options message may include the challenges and rewards offered to the user. The options message may also include the verification requirements for the challenge and the access requirements for the challenge.

The verification requirements for the challenge may indicate the proof that the user may be required to submit to properly verify completion of the challenge. For example, the verification requirements for the challenge may include pictures or videos that may verify completion of the challenge, Global Positioning System (GPS) coordinates or background location data that may verify a location of the user during performance or completion of the challenge, social media postings that may verify during performance or completion of the challenge, witness verification data in which a witness may separately verify that the user completed the challenge, messages describing details that may be used to verify completion of the challenge, purchase receipts that may verify completion of the challenge, smart wearable device data that may verify performance or completion of the challenge, connected device data that may verify performance or completion of the challenge, etc.

The access requirements for the challenge may indicate data that the UE may need to access and share with the server to properly verify completion of the challenge. For example, the access requirements may indicate that the UE may need to access and share GPS data, background location data, social media data, private message data, purchase history data, smart wearable device data, and/or connected device data with the server to verify completion of the challenge.

The UE may receive the options message and display the challenges and rewards to the user on a user interface of the UE for the user to select one or more challenges and one or more corresponding rewards to participate in, to potentially claim the reward upon completing the challenge. Upon selecting the challenges and rewards, the UE may be triggered to begin collecting verification data based on the verification requirements and the access requirements indicated in the options message.

The verification data may include, for example, location data, GPS coordinates, pictures, videos, smart wearable device data, connected device data, purchase history data, user data, social media data, etc. For example, when the challenge is related to the user completing a hike, the verification data may include location data and GPS coordinates, collected by the UE in the background, in which this data may be used to determine whether the user was indeed at the location of the hike at the time indicated by the user. In this challenge, the verification data may include a picture of the user at the top of the hike. This picture may be manually uploaded to a client application at the UE instead of being collected in the background, or may be automatically collected when the user posts the picture to a social media platform.

As another illustrative example, when the challenge is related to purchasing one or more products, the verification data may include pictures of the purchased products and pictures of the receipts of the products. The user may manually upload these pictures to a client application installed at the UE instead of being collected in the background. The pictures or videos may also be collected automatically by the client application when the user posts these pictures or videos to a social media platform.

As yet another illustrative example, when the challenge is related to a weight loss goal for the user (e.g., lost 2 pounds in one month), the verification data may include smart watch data indicating calories burned during workouts performed by the user, connected device data indicating weight fluctuations of the user recorded by a BLUETOOTH connected weighing scale, and pictures of food items consumed by the user. The client application may collect the smart watch data and the connected device data in the background.

The client application of the UE may then transmit the collected verification data to the verification application at the server. The verification application may determine a confidence score of the verification data based on various criteria. The confidence score may be a value between 0 to 1, or any other numerical value. The confidence score may represent a likelihood that the user successfully completed the challenge (i.e., performed all of the tasks of the challenge). The verification application may determine a different confidence score for each type of verification data. For example, when the verification requirements for a challenge includes picture data, GPS data, and smart watch data, the verification application may determine the confidence score separately for the picture data, the GPS data, and the smart watch data. The verification application may then determine the confidence score based on an average of the separate confidence scores for the picture data, the GPS data, and the smart watch data.

The confidence score may be based on a level of matching between the provided verification data and expected verification data. The expected verification data may be data that has been verified as proving a user completion of the challenge. For example, the verification application may determine the confidence score based on a level of matching between the expected verification data and the provided verification data, in which the level of matching refers to a representation of similarities or differences between the provided verification data and the expected verification data. For example, a picture showing a user at the top of the mountain in a hike, in which the face of the user is displayed in the picture, may have a higher confidence score than background location data indicates that user is a few miles away from the hike. This may be because the expected verification data may similarly include a picture of a user at the top of a hike, and thus, the provided verification data of the foregoing picture with the user substantially matches the expected verification data. As another example, connected device data indicating weight changes of the user may have a higher confidence score for a weight loss challenge than a picture of food items consumed by the user. This may be because the expected verification data includes weight loss data, not pictures of food.

The verification application may also consider environmental factors that may weigh in to the quality of the verification data when determining the confidence score of the verification data. For example, GPS signals may be blocked because of weather conditions, and thus, the verification application may determine that these GPS coordinates have a lower confidence score due to the poor signal quality of the GPS signals.

In some cases, the verification application may determine a confidence score using, for example, a machine learning model that is trained based on similar challenge and reward data from the user and/or other users. The machine learning model may also include a facial recognition algorithm, which may be used to verify the presence of the user in the pictures submitted as verification data. The machine learning model may also include, for example, object recognition algorithms, background recognition algorithms, text parsing abilities, and other neural networking models to train data and predict results accurately and efficiently. In some cases when the machine learning model is not trained enough to determine a confidence score with accuracy, additional verification may be required or requested to better verify completion of the challenge.

One or more threshold values may be set to determine whether a reward should be offered to the user or whether further verification may be required. For example, a first threshold may be set, and the reward application may transmit a code (e.g., QR code) to the UE to claim the reward when the confidence score exceeds the first threshold. A second threshold may be set, such that the verification application may transmit a request to the UE for additional verification data when the confidence score exceeds the second threshold, but not the first threshold. In this case, the first threshold may be greater than the second threshold. In this context, the reward application may transmit, to the UE, a message indicating that user did not pass completion of the challenge and is not granted the reward when the confidence score falls below the second threshold.

The user may claim the reward by scanning the code at the UE, which may then transmit a request to claim the reward back to the enterprise server. The enterprise server may then be trigger to transmit the reward, in the form of promotional data, back to the UE such that the user may obtain the benefits of the reward.

In an embodiment, a user may request a customized reward instead of one of the predefined rewards offered to the user in the options message. The user may select an icon or text box on the UE to enter in a customized reward (e.g., a free product/service), and the UE may transmit the customized reward back to the enterprise server for approval (either through the server or bypassing the server entirely). The enterprise server may approve the customized reward based on various business factors, and send either an acceptance or rejection message back to the UE (again, either through the server or bypassing the server). When the UE receives a rejection message indicating that the customized reward request is rejected, the UE may again request another customized reward again to negotiate a desired reward. The foregoing process may repeat until the enterprise server sends an acceptance message to the UE indicating acceptance of the customized reward.

In an embodiment, the verification requirements for a challenge may include witness verification data, in which a witness UE separate from the UE may need to separately transmit witness verification data to the server to prove that the user completed the challenge. The UE or the server may send a request to the witness UE for witness verification data. The witness verification data may include, for example, a simple typed message indicating that the user indeed completed the challenge, a picture/video of the user completing the challenge, or some other secondary form of verification, which may be used to attest to the user completing the challenge.

The witness verification data may be sent to the server, and the verification application may first verify the witness before using the witness verification data in determining the confidence score. For example, the verification application may verify the identity of the witness based on whether an identifier of the witness UE is registered with the witness in the user data stored at the data store. The identity verification of the witness may also be based on a location of the witness UE relative to a location of the user completing the challenge (e.g., the witness and the user were located at the same place when the verification data is received), publicly available data that may be used to confirm the identity of the witness, and/or other types of data.

As disclosed herein, promotional data is not transmitted to a user unless the user meets a series of stringent verification requirements for completing a challenge. This heavily reduces the quantity of promotional data processed at a server and forwarded through a network. In these embodiments, the system only sends promotional data to users that have actively expressed interest in the rewards included in the promotional data. In this way, the embodiments disclosed herein also increases the likelihood that processed and sent promotional data successfully brings revenue to the companies offering the challenges and rewards.

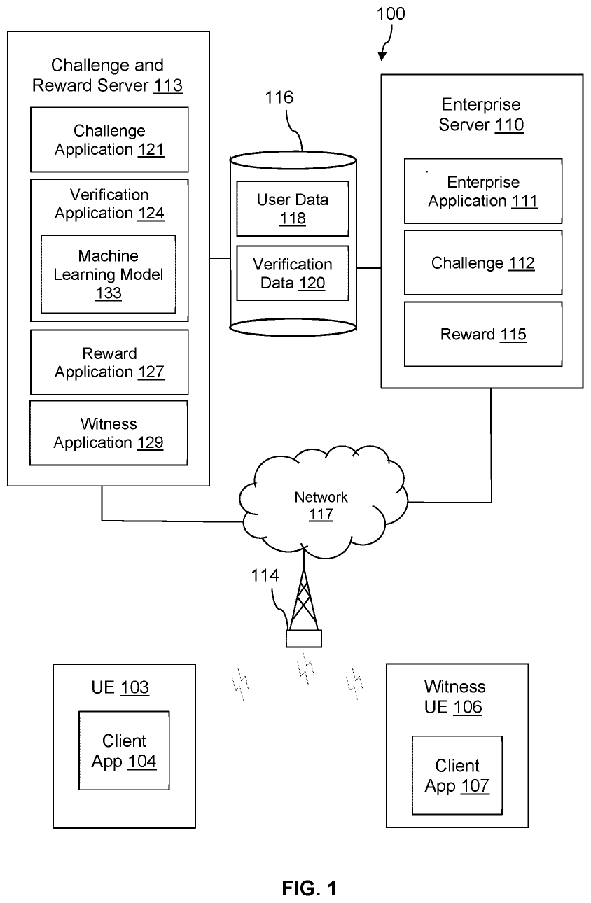

Turning now to FIG. 1, a communication system 100 is described. The system 100 comprises a user equipment (UE) 103, a witness UE 106, a cell site 114, and a network 117, an enterprise server 110, a challenge and reward server 113 (referred to herein as “server 113”), and a data store 116. The UE 103 and the witness UE 106 may be communicatively coupled to the enterprise server 110, server 113, and network 117 via the cell site 114.

The UE 103 and the witness UE 106 may each be a cell phone, a mobile phone, a smart phone, a personal digital assistant (PDA), an Internet of things (IoT) device, a wearable computer, a headset computer, a laptop computer, a tablet computer, or a notebook computer. The UE 103 includes a client application 104 to select challenges and rewards, and upload verification data 120 according to the embodiments described herein. The witness UE 106 also includes a client application 107 to receive requests for witness verification data and upload witness verification data according to the embodiments described herein. The cell site 114 may provide the UE 103 and the witness UE 106 a wireless communication link to the enterprise server 110, server 113, and network 117 according to a 5G, a long term evolution (LTE), a code division multiple access (CDMA), or a global system for mobile communications (GSM) wireless telecommunication protocol.

The network 117 may be one or more private networks, one or more public networks, the Internet, or a combination thereof. While FIG. 1 shows the enterprise server 110, server 113, and data store 116 as being separate from the network 117, it should be appreciated that, in some embodiments, at least a portion of the enterprise server 110, server 113, and data store 116 may be part of the network 117.

As shown in FIG. 1, the enterprise server 110 includes an enterprise application 111 used to generate the challenges 112 and the rewards 113. A challenge 112 refers to one or more tasks that are to be completed by the user to claim one or more rewards 115. The rewards 115 refer to the free or discounted product/service, job or job promotion, award or recognition, etc., received in response to the user completing a challenge 112. In an embodiment, the enterprise application 111 may determine challenges 112 and rewards 115 for a user based on user data 118 of the user stored in the data store 116 communicatively coupled to the enterprise server 110. The user data 118 may include biographical data (age, geographical location, gender, hobbies, skills, etc.), prior accepted challenges 112 of the user, and prior claimed rewards 115.

The server 113 may include a challenge application 121, a verification application 124, a reward application 127, and a witness application 129, among other applications and services. For example, the challenge application 121, verification application 124, reward application 127, and witness application 129 may be each stored as separate instruction in one or more memories that are executable by one or more processors in the server 113.

The challenge application 121 may obtain the challenges 112 and rewards 115 from the enterprise server 110 and generate an options message. The options message may include the challenges 112 and rewards 115 offered to the user. The options message may also include the verification requirements for the challenge 112 and the access requirements for the challenge 112. The verification requirements for the challenge 112 may indicate the proof, in the form of verification data 120, that the user may be required to submit to properly verify completion of the challenge. The access requirements for the challenge may indicate data to which the UE 103 may be required to access and share with the server 113 to verify completion of the challenge 112. The challenge application 121 may transmit the options message to the UE 103.

The UE 103 may receive the options message, and the user may select one of the listed challenges and one or more rewards via a user interface displayed on the UE 103 by the client application 104. Upon selecting the challenges 112 and rewards 115, the UE 103 may be triggered to begin collecting verification data 120 based on the verification requirements and the access requirements indicated in the options message. The client application 104 of the UE 103 may transmit the collected verification data 129 to the verification application 124 at the server 113. The verification application 124 may determine a confidence score of the verification data 120, as described above. The confidence score may represent a likelihood that the user successfully completed the challenge 112. In some embodiments, the verification application 124 may determine the confidence score of the verification data using a machine learning model 133 that is trained based on similar challenge and reward data from the user and/or other users. The machine learning model may include, for example, natural language processing, facial recognition algorithms, object recognition algorithms, background recognition algorithms, text parsing abilities, and other neural networking models to train data and predict results accurately and efficiently. When the confidence score is above a threshold, the reward application 127 may transmit a code to the UE 103, which the client application 104 may use to claim the reward 115 from the enterprise server 110. When the confidence score is below a threshold, the reward application 127 may transmit, to the UE 103, a message indicating that user did not pass completion of the challenge 112 and is not granted the reward 115.

When the verification requirements require witness verification data, the witness application 129, or the client application 104, may transmit a request for witness verification data to the witness UE 106. The client application 107 at the witness UE 106 may obtain witness verification data, and manually or automatically upload the witness verification data to the server 113. The witness application 129 may verify the identity of the witness operating the witness UE 106, for example, based on whether an identifier or phone number behind the witness UE 106 matching a registered profile of the witness, as indicated in the user data 118. The witness application 129 may verify the identity of the witness in other manners not otherwise limited by the disclosure herein. After verifying the identity of the witness and the witness UE 106 and after receiving the witness verification data, the verification application 124 may determine the confidence score based additionally on the witness verification data.

In an embodiment, the enterprise server 110 and the server 113 may be one or more computing devices, with power, storage, networking, and processing resources used to implement the embodiments disclosed herein. While FIG. 1 shows the server 113 and the data store 116 as being separate from the enterprise server 110, in an embodiment, the server 113 and the data store 116 may be implemented as part of the enterprise server 110 architecture. In another embodiment, the server 113 and the data store 116 may be separated from the enterprise server 110, such that enterprise servers of multiple different business enterprises may use the same server 113 to provide challenges and rewards according to the embodiments disclosed herein.

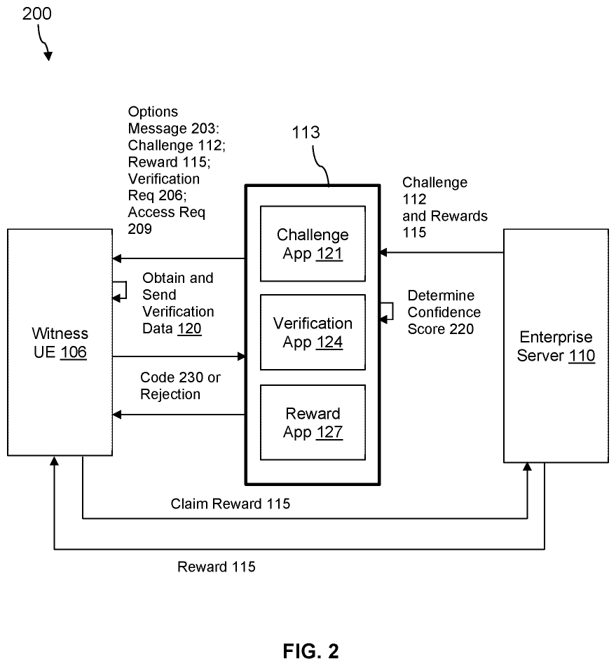

Turning now to FIG. 2, a block diagram illustrating an example method 200 performed by the communication system 100 of FIG. 1 is described. Method 200 may be performed by the UE 102, the enterprise server 110, and the server 113. More specifically, method 200 may be performed by the challenge application 121, verification application 124, and reward application 127 of the server 113.

As shown in FIG. 2, the enterprise server 110 first determines the challenges 112 and rewards 115 to offer the user operating the UE 103, and forwards the determined challenges 112 and rewards 115 to the challenge application 121. The challenge application 121 may determine the verification requirements 206 and access requirements 209 for the user to successfully prove completion of the challenge 112. The challenge application 121 may then generate an options message 203 indicating the challenges 112, the rewards 115, the verification requirements 206, and the access requirements 209, and send the options message 203 to the UE 103.

The user may select one or more challenges 112 to participate in to claim the reward 115 using the client application 104 of the UE 103. Upon selecting a challenge 112, the client application 104 may be triggered to collect verification data 120 automatically in the background based on the access requirements 209 or request the user to manually upload relevant verification data 120. The verification data 120 for the challenge 112 may be based on the verification requirements 206 included in the options message 203. After collecting the verification data 120, the UE 103 may transmit the verification data 120 to the verification application 124.

The verification application 124 may determine a confidence score 220 indicating a likelihood that the user completed the challenge 112 based on the different types of verification data 120 received for the challenge 112, as outlined above. The reward application 127 may respond to the UE 103 with either a code to claim the reward 115 or a rejection message indicating that the user did not complete the challenge 112 based on whether the confidence score 220 meets one or more pre-defined thresholds. If the confidence score 220 exceeds the threshold, the reward application 127 may transmit a code 230 to the UE 103, such that the client application 104 may use the code to claim the reward 115 with the enterprise server 110. As shown in FIG. 2, the claiming of the reward 115 may entirely bypass the server 113. But in another embodiment, the claiming of the reward 115 may include messages forwarded through the server 113. The enterprise server 110 may then transmit the reward 115 back to the UE 103 in a similar fashion so that the user gains the benefit of the reward 115.

Various examples of challenge 112 and reward 115 pairings are further described herein. For example, a business (e.g., carrier network provider) may offer a challenge 112 to a user to hike to nearby mountain/waterfall, develop a new business idea, perform a speed test (in comparison with another carrier network provider), etc., and then post on social media with a hashtag of the name of the carrier network provider. The corresponding rewards 115 presented to the user may include an offer for free data or unlimited data for a period of time, free streaming media for a period of time, a free international data pass for a period of time, etc.

A sporting goods company may offer a challenge 112 to a user to win a sport game or competition, show off athletic abilities, lose some weight and post a picture/video on social media with a hashtag of the name of the sporting goods company. The corresponding rewards 115 presented to the user may include an offer for new shoes, new apparel, gift cards, gifts for friends or relatives, free tickets to the game, an opportunity to meet a player, etc.

A restaurant or fast food chain may offer a challenge 112 to a user to jog for a period of time in the morning, capture the heartbeat on a smartwatch of the user, and post a picture/video on social media with a hashtag of the name of the restaurant or fast food chain. The corresponding rewards 115 presented to the user may include an offer for free coffee, drink, or meal.

A home improvement retail store may offer a challenge 112 to a user to perform home improvement projects and post a picture/video on social media with a hashtag of the name of the retail store. The corresponding rewards 115 presented to the user may include an offer for free tools or materials for future home improvement projects.

The rewards 115 described above may be in the form of a coupon. The coupon may be accessed when the user receives a bar code or coupon code, which when scanned, presents the user with the coupon.

Multiple businesses may collaborate to generate revenue for one another by cross-correlating challenges 112 and rewards 115. The business issuing the challenge 112 may compensate partner businesses once a reward 115 has been claimed. In this way, business may use revenue to partner with other businesses to target customers in a collaborated fashion instead of wasting revenue on sending advertisements to customers that may be ignored. For example, retail stores may offer challenges 112 to purchase items from the retail store, and the corresponding reward 115 may be an offer to the user for a free food or drink item from a restaurant (i.e., the retail store issues the challenge 112 while the restaurant issues the reward 115). The retail store and the restaurant may enter into an agreement whereby the restaurant compensates the retail store in some fashion for providing an incentive for a customer of the retail store to enter the restaurant. Business may do the same with entertainment or vacation destinations. For example, an IT company may offer a challenge 112 to employees to take a certificate training and/or pass a test, and a cruise company may offer a reward 115 for a free or discounted cruise if the employees complete the challenge 112. The IT company may enter into an agreement with the cruise company whereby the IT company compensates the cruise company for providing an incentive for employees to take the certificate training and test, which will ultimately increase the revenue of the company.

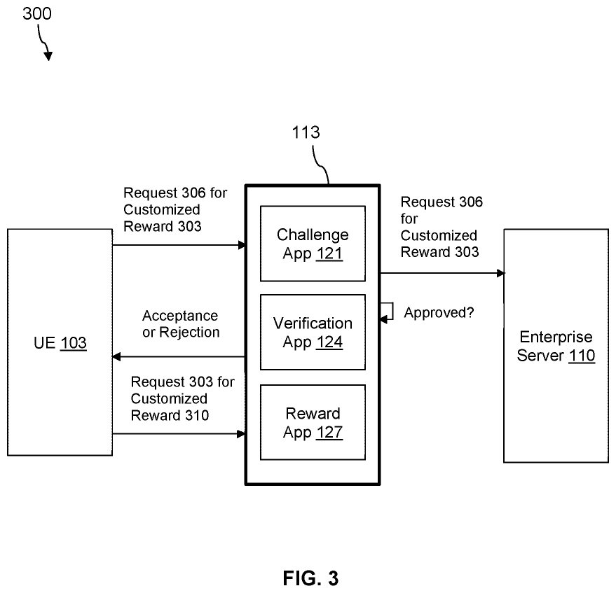

Turning now to FIG. 3, a block diagram illustrating an example method 300 performed by the communication system 100 of FIG. 1 is described. Method 300 is performed by the UE 103, the enterprise server 110, and the server 113. More specifically, method 300 is performed by the challenge application 121, verification application 124, and reward application 127 of the server 113. Method 300 may be performed to request a customized reward 303 for the user when completing a challenge 112.

The customized reward 303 may be any reward that is not included in the pre-defined rewards 115 created by the enterprise server 110 as described above. The customized reward 303 may be, for example, a discount or code for a product or service not identified in the pre-defined rewards 115, an award or accolade for completing a challenge, an offer for a job or promotion, an offer for a position in a volunteer organization, etc.

The user may enter the customized reward into the client application 104 at the UE 103. For example, the user may enter text corresponding to the customized reward into a UI of the UE 103. The text may recite, for example, “a free pair of brand X trousers.” The client application 104 may generate a request 306 for the customized reward 303 including the text inputted at the UE 103. The client application 104 may forward the request 306 to the challenge application 121, and the challenge application 121 may record the request 306 for the customized reward 303 in the data store 116 with an identity of the user or the UE 103.

The challenge application 121 may forward the request 306 to the enterprise server 110. The enterprise server 110 may determine whether to approve the customized reward 303 for the user based on a variety of factors, such as, for example, business decisions and network factors. The business may determine whether to provide the customized reward 303 to the user based on business decisions by determining, for example, whether providing the customized reward 303 would impact cost or revenue of the business, such that providing the customized reward 303 would be reasonable/unreasonable. Network factors may also impact whether the business enterprise may provide the customized reward 303 to the user. For example, the verification data 120 required to prove completion of the challenge 112 may be larger in size, thus affecting network resources (e.g., bandwidth, latency, throughput, etc.) to an unreasonable extent. Different business enterprises may only be allocated a certain amount of network resources, and if providing customized rewards 303 forwarding verification data 120 for the customized rewards 303 violates the network resource permissions, then such a customized reward 303 may need to be rejected.

The enterprise server 110 may generate a message indicating whether the request 306 for the customized reward 303 is approved and forward the message to the verification application 124. The verification application 124 may scan the message to determine whether the customized reward 303 is approved and forward an acceptance or rejection back to the UE 103.

When the request 306 for the customized reward is rejected, the user may continue to negotiate with the business enterprise for another customized reward 303 using the process described above. For example, the user may again send another request 306 for a different customized reward 310 to the challenge application 121, which may be forwarded to the enterprise server 110 for approval or disapproval, and so on.

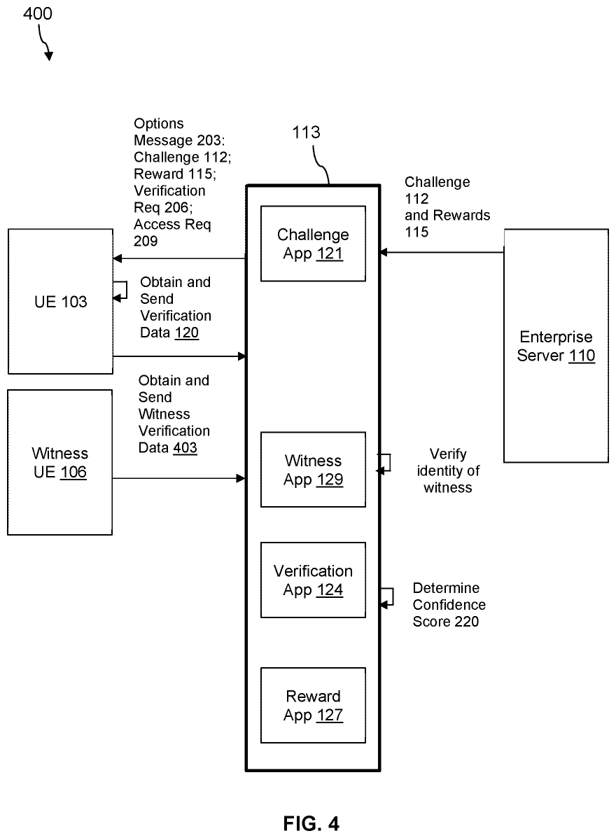

Turning now to FIG. 4, a block diagram illustrating an example method 400 performed by the communication system 100 of FIG. 1 is described. Method 400 is performed by the UE 103, the enterprise server 110, and the server 113. More specifically, method 400 may be performed by the challenge application 121, verification application 124, witness application 129, and reward application 127 of the server 113. Method 400 may be performed when the verification requirements 206 for a challenge 112 includes witness verification data 403.

Method 400 is similar to method 200, except that a witness UE 106 transmits witness verification data 403 to the verification application 124 before the verification application 124 determines a confidence score 220 based on the verification data 120 (including the witness verification data 403). In addition, method 400 includes the additional step of the witness application 129 verifying the identity of the witness or the witness UE 106 before the verification application 124 determines the confidence score 220 based on the verification data 120 (including the witness verification data 403).

In an embodiment, the server 113 or UE 103 may request the witness UE 106 to transmit witness verification data 403 to the verification application 124. A client application 107 of the witness UE 106 may display a UI by which the witness may enter or upload the witness verification data 403. For example, if the challenge 112 involves winning a competition, and the verification requirements 206 for this challenge 112 may include witness verification data 403, in which the witness may need to verify that the user is an active member of the competing team and contributed to winning the competition (in addition to the other verification data 120 submitted by the UE 103). The witness may be an official of the competition, an organizer, a school principal, a teacher, a teammate, a friend of relative who was viewing the competition, etc.

The witness may manually or automatically enter witness verification data 403 verifying that the user is an active member of the competing team and contributed to winning the competition through the client application 107 of the witness UE 106. The witness verification data 403 may include, for example, a message merely stating that the user is an active contributing member of the winning team or a photo/video of the user actively contributing to the team. The witness verification data 403 may also include location data or GPS coordinates of the witness, confirming that the witness and UE were at the same location during performance or completion of the challenge. The witness UE 106 may transmit this witness verification data 403 to the verification application 124 and/or the witness application 129 in a message, for example, including an identifier or an address of the witness UE 106.

The witness application 129 may first verify an identity of the witness, for example, using the identifier or address of the witness UE 106 to ensure that the identifier or address of the witness UE 106 received with the witness verification data 403 matches an identifier or address of the witness UE 106 registered with the witness. For example, the witness application 129 may compare the identifier or address of the witness UE 106 with identifier or address of the witness UE 106 stored at the user data 118 to verify the identity of the witness (i.e., if the data matches, the witness is verified, and if the data does not match, the witness is not verified). The witness application 129 may also verify that the location data or GPS coordinates of the witness UE 106 matches the location data or GPS coordinates of the UE 103, when the UE 103 was participating in the competition. In this way, witness application 129 may provide multiple layers of authentication for the witness before the witness verification data 403 may be used to determine the confidence score 220. The witness verification data 403 may either increase or decrease the confidence score 220 depending on the strength of the witness verification data 403 in corroborating that the user completed the challenge 112.

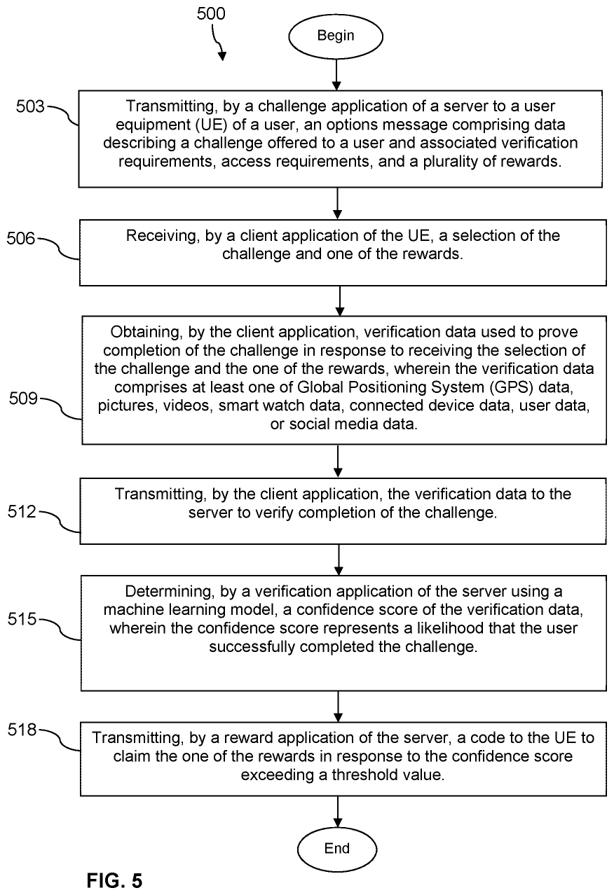

Turning now to FIG. 5, shown is a flow chart of first method 500 performed by the system of FIG. 1. Method 500 may be performed by the challenge application 121, verification application 124, and reward application 127 of the server 113, and the client application 104 of the UE 103.

At step 503, method 500 comprises transmitting, by the challenge application 121 to the UE 103, an options message 203 comprising data describing a challenge 112 offered to a user and associated verification requirements 206, access requirements 209, and a plurality of rewards 115. At step 506, method 500 comprises receiving, by a client application 104 of the UE 103, a selection of the challenge 112 and one of the rewards 115. At step 509, method 500 comprises obtaining, by the client application 104, verification data 120 used to prove completion of the challenge 112 in response to receiving the selection of the challenge 112 and the one of the rewards 115. In an embodiment, the verification data 120 comprises at least one of GPS data, pictures, videos, smart watch data, connected device data, user data, or social media data. At step 512, method 500 comprises transmitting, by the client application 104, the verification data 120 to the server 113 to verify completion of the challenge 112. At step 515, method 500 comprises determining, by the verification application 124 using a machine learning model 133, a confidence score 220 of the verification data 120. In an embodiment, the confidence score 220 may represent a likelihood that the user successfully completed the challenge 112. At step 518, method 500 comprises transmitting, by the reward application 127, a code 230 to the witness UE 106 to claim the one of the rewards 115 in response to the confidence score 220 exceeding a threshold value.

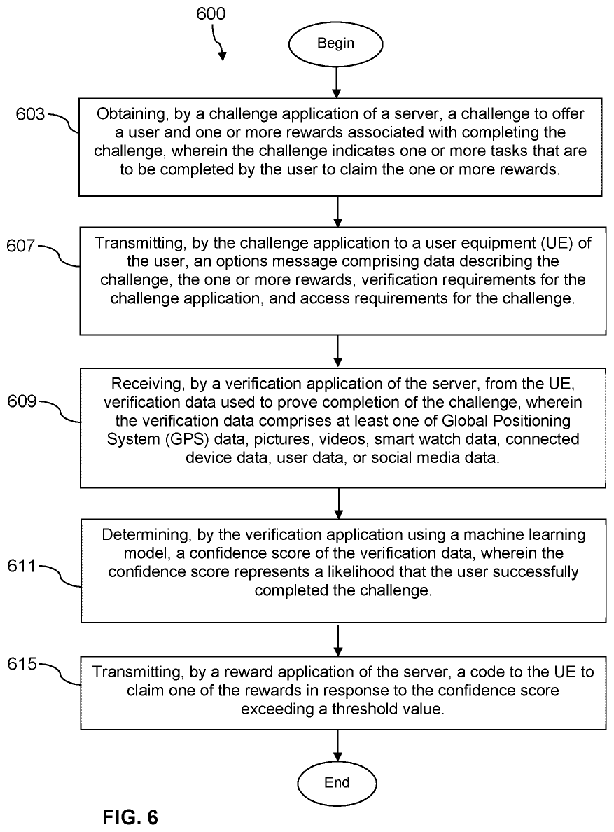

Turning now to FIG. 6, shown is a flow chart of second method 600 performed by the system of FIG. 1. Method 600 may be performed by the challenge application 121, verification application 124, and reward application 127 of the server 113.

At step 603, method 600 comprises obtaining, by the challenge application 121, a challenge 112 to offer a user one or more rewards 115 associated with completing the challenge 112. In an embodiment, the challenge 112 indicates one or more tasks that are to be completed by the user to claim the one or more rewards 115. At step 607, method 600 comprises transmitting, by the challenge application 121 to the UE 103, an options message 202 comprising data describing the challenge 112, the one or more rewards 115, verification requirements 206 for the challenge application 121, and access requirements 113 for the challenge 112. At step 609, method 600 comprises receiving, by the verification application 123, from the UE 103, verification data 120 used to prove completion of the challenge 112. In an embodiment, the verification data 120 comprises at least one of GPS data, pictures, videos, smart watch data, connected device data, user data, or social media data. At step 611, method 600 comprises determining, by the verification application 124 using a machine learning model 133, a confidence score 220 of the verification data 120. In an embodiment, the confidence score 220 represents a likelihood that the user successfully completed the challenge 112. At step 615, method 600 comprises transmitting, by the reward application 127, a code 230 to the UE 103 to claim one of the rewards 115 in response to the confidence score 220 exceeding a threshold value.

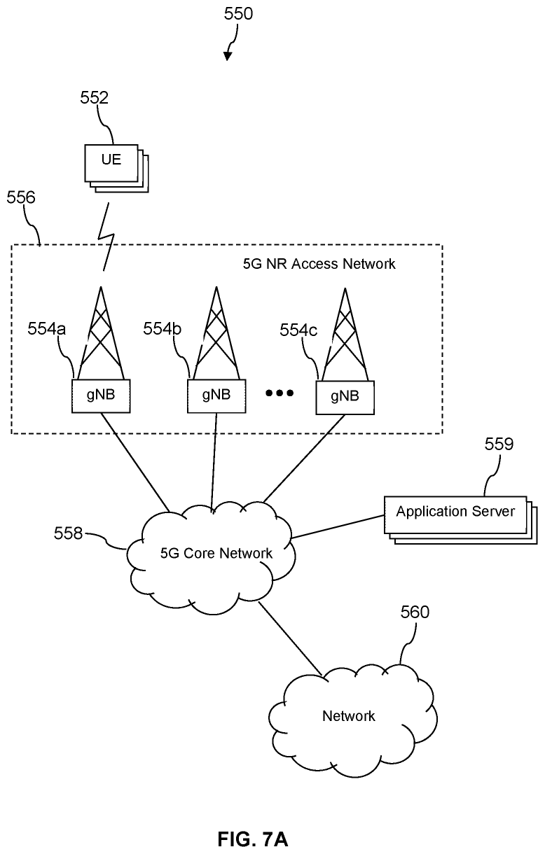

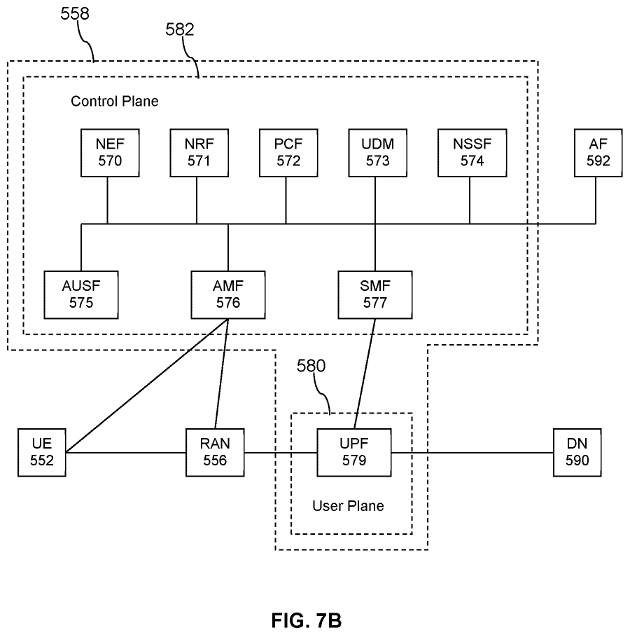

Turning now to FIG. 7A, an exemplary communication system 550 is described. In an embodiment, the communication system 550 may be implemented in the system 100 of FIG. 1. The communication system 550 includes a number of access nodes 554 that are configured to provide coverage in which UEs 552, such as cell phones, tablet computers, machine-type-communication devices, tracking devices, embedded wireless modules, and/or other wirelessly equipped communication devices. The access nodes 554 may be said to establish an access network 556. The access network 556 may be referred to as RAN in some contexts. In a 5G technology generation an access node 554 may be referred to as a gigabit Node B (gNB). In 4G technology (e.g., LTE technology) an access node 554 may be referred to as an eNB. In 3G technology (e.g., CDMA and GSM) an access node 554 may be referred to as a base transceiver station (BTS) combined with a base station controller (BSC). In some contexts, the access node 554 may be referred to as a cell site or a cell tower. In some implementations, a picocell may provide some of the functionality of an access node 554, albeit with a constrained coverage area. Each of these different embodiments of an access node 554 may be considered to provide roughly similar functions in the different technology generations.

In an embodiment, the access network 556 comprises a first access node 554a, a second access node 554b, and a third access node 554c. It is understood that the access network 556 may include any number of access nodes 554. Further, each access node 554 could be coupled with a core network 558 that provides connectivity with various application servers 559 and/or a network 560. In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554 and could thereby communicate via the access node 554 with various application servers and other entities.

The communication system 550 could operate in accordance with a particular radio access technology (RAT), with communications from an access node 554 to UEs 552 defining a downlink or forward link and communications from the UEs 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”-such as Long Term Evolution (LTE), which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IoT) and machine to machine areas.

In accordance with the RAT, each access node 554 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in radio-frequency (RF) spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554 to served UEs 552. And on the uplink, certain resource elements could be reserved to carry random access signaling from UEs 552 to the access node 554, and other resource elements could be reserved to carry other control signaling such as PRB-scheduling requests and acknowledgement signaling from UEs 552 to the access node 554.

The access node 554, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 7B, further details of the core network 558 are described. In an embodiment, the core network 558 is a 5G core network. 5G core network technology is based on a service based architecture paradigm. Rather than constructing the 5G core network as a series of special purpose communication nodes (e.g., an HSS node, an MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 575, an access and mobility management function (AMF) 576, a session management function (SMF) 577, a network exposure function (NEF) 570, a network repository function (NRF) 571, a policy control function (PCF) 572, a unified data management (UDM) 573, a network slice selection function (NSSF) 574, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 580 and a control plane 582, thereby promoting independent scalability, evolution, and flexible deployment.

The UPF 579 delivers packet processing and links the UE 552, via the access network 556, to a data network 590 (e.g., the network 560 illustrated in FIG. 7A). The AMF 576 handles registration and connection management of non-access stratum (NAS) signaling with the UE 552. Said in other words, the AMF 576 manages UE registration and mobility issues. The AMF 576 manages reachability of the UEs 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and IP address management functions. The AUSF 575 facilitates security processes.

The NEF 570 securely exposes the services and capabilities provided by network functions. The NRF 571 supports service registration by network functions and discovery of network functions by other network functions. The PCF 572 supports policy control decisions and flow based charging control. The UDM 573 manages network user data and can be paired with a user data repository (UDR) that stores user data such as customer profile information, customer authentication number, and encryption keys for the information. An application function 592, which may be located outside of the core network 558, exposes the application layer for interacting with the core network 558. In an embodiment, the application function 592 may be executed on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 574 can help the AMF 576 to select the network slice instance (NSI) for use with the UE 552.

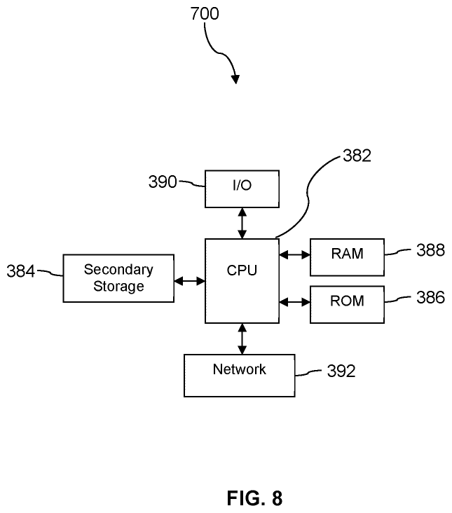

FIG. 8 illustrates a computer system 700 suitable for implementing one or more embodiments disclosed herein. In an embodiment, the UE 103, witness UE 106, server 113, and enterprise server 110 may be implemented as the computer system 700. The computer system 700 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 700, at least one of the CPU 382, the RAM 388, and the ROM 386 are changed, transforming the computer system 700 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 700 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 700 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 700 to provide the functionality of a number of servers that is not directly bound to the number of computers in the computer system 700. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 700, at least portions of the contents of the computer program product to the secondary storage 384, to the ROM 386, to the RAM 388, and/or to other non-volatile memory and volatile memory of the computer system 700. The processor 382 may process the executable instructions and/or data structures in part by directly accessing the computer program product, for example by reading from a CD-ROM disk inserted into a disk drive peripheral of the computer system 700. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 700.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 700 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. A system comprising:
a user equipment associated with a user; and
a server comprising:
at least one processor;
at least one non-transitory memory; and
a challenge application, stored in the at least one non-transitory memory, which when executed by the at least one processor, causes the at least one processor to be configured to:
obtain a challenge to offer a user and one or more rewards associated with completing the challenge, wherein the challenge indicates one or more tasks that are to be completed by the user to claim the one or more rewards;
transmit, to the UE, an options message comprising data describing the challenge, the one or more rewards, verification requirements for the challenge, and access requirements for the challenge;
a verification application, stored in the at least one non-transitory memory, which when executed by the at least one processor, causes the at least one processor to be configured to:
receive feedback data including other challenge data for other challenges similar to the challenge and other reward data corresponding to the other challenge data, each for users other than the user;
retrain a machine learning mode based on the feedback data to form a retrained machine learning model;
receive, from the UE, verification data used to prove completion of the challenge, wherein the verification data comprises at least one of Global Positioning System (GPS) data, pictures, videos, smart watch data, connected device data, user data, or social media data; and
determine, using the retrained machine learning model, a confidence score of the verification data, wherein the confidence score represents a likelihood that the user successfully completed the challenge, wherein determining the confidence score by processing the verification data with the retrained machine learning model improves accuracy of the determination of the confidence score in comparison to processing the verification data with the machine learning model; and
a reward application, stored in the at least one non-transitory memory, which when executed by the at least one processor, causes the at least one processor to be configured to transmit a code to the UE to claim one of the rewards in response to the confidence score exceeding a threshold value.

2. The system of claim 1, wherein the challenge application further causes the at least one processor to be configured to receive a message from an enterprise server associated with a business enterprise, wherein the message comprises the challenge and the one or more rewards.

3. The system of claim 1, wherein the challenge application further causes the at least one processor to be configured to:
obtain user data from a data store communicatively coupled to the server, wherein the user data comprises at least one of past challenges completed by the user, past rewards received by the user, general user information, current and prior location data of the user, social media history of the user, prior recorded hobbies, or prior recorded skills; and
determine the challenge and the one or more rewards based on the user data.

4. The system of claim 1, wherein the reward application further causes the at least one processor to be configured to.
receive, from the UE, a request for a customized reward instead of the one or more rewards;
forward the request to an enterprise server associated with a business enterprise, wherein the business enterprise is offering the one or more rewards in return for completing the challenge;
receive, from the enterprise server, an indication as to whether the business enterprise approved the customized reward; and
transmit, to the UE, an acceptance or rejection message indicating whether the business enterprise approved the customized reward.

5. The system of claim 1, wherein the verification data comprises a plurality of different types of data, and wherein the confidence score is based on an average of different confidence scores for each of the different types of data.

6. The system of claim 1, wherein the machine learning model comprises a facial recognition algorithm, and wherein the machine learning model is trained using other verification data from other users that completed a similar challenge.

7. The system of claim 1, further comprising a witness application, stored in the at least one non-transitory memory, which when executed by the at least one processor, causes the at least one processor to be configured to receive a message from a witness UE comprising witness verification data further verifying that the user is progressing toward or successfully completed the challenge, wherein the data comprises at least one of a text message, a picture, a video, or GPS data.

8. A method performed by a challenge and reward system, wherein the method comprises:
obtaining, by a challenge application of a server, a challenge to offer a user and one or more rewards associated with completing the challenge, wherein the challenge indicates one or more tasks that are to be completed by the user to claim the one or more rewards;
transmitting, by the challenge application to a user equipment (UE) of the user, an options message comprising data describing the challenge, the one or more rewards, verification requirements for the challenge, and access requirements for the challenge;
receiving, by the server, feedback data including other challenge data for other challenges similar to the challenge and other reward data corresponding to the other challenge data, each for users other than the user;
retraining, by the server, a machine learning mode based on the feedback data to form a retrained machine learning model;
receiving, by a verification application of the server, from the UE, verification data used to prove completion of the challenge, wherein the verification data comprises at least one of Global Positioning System (GPS) data, pictures, videos, smart watch data, connected device data, user data, or social media data;
determining, by the verification application using the retrained machine learning model, a confidence score of the verification data, wherein the confidence score represents a likelihood that the user successfully completed the challenge, wherein determining the confidence score by processing the verification data with the retrained machine learning model improves accuracy of the determination of the confidence score in comparison to processing the verification data with the machine learning model; and
transmitting, by a reward application of the server, a code to the UE to claim one of the rewards in response to the confidence score exceeding a threshold value.

9. The method of claim 8, wherein obtaining the challenge and the one or more rewards comprising receiving, by the challenge application, a message from an enterprise server associated with a business enterprise, wherein the message comprises the challenge and the one or more rewards.

10. The method of claim 8, wherein obtaining the challenge and the one or more rewards comprising:
obtaining, by the challenge application, user data from a data store communicatively coupled to the server, wherein the user data comprises at least one of past challenges completed by the user, past rewards received by the user, general user information, current and prior location data of the user, social media history of the user, prior recorded hobbies, or prior recorded skills; and
determining, by the challenge application, the challenge and the one or more rewards based on the user data.

11. The method of claim 8, further comprising:
receiving, by the reward application from the UE, a request for a customized reward instead of the one or more rewards;
forwarding, by the reward application, the request to an enterprise server associated with a business enterprise, wherein the business enterprise is offering the one or more rewards in return for completing the challenge;
receiving, by the reward application from the enterprise server, an indication as to whether the business enterprise approved the customized reward; and
transmitting, by the reward application to the UE, an acceptance or rejection message indicating whether the business enterprise approved the customized reward.

12. The method of claim 8, wherein the verification data comprises a plurality of different types of data, wherein the determining, by the verification application of the server using the machine learning model, the confidence score of the verification data comprises determining a different confidence score for each of the different types of data using the trained machine learning model, wherein the confidence score is based on an average of the different confidence scores for each of the different types of data.

13. The method of claim 8, wherein the machine learning model comprises a facial recognition algorithm.

14. A method performed by a challenge and reward system, wherein the method comprises:
transmitting, by a challenge application of a server to a user equipment (UE) of a user, an options message comprising data describing a challenge offered to a user and associated verification requirements, access requirements, and a plurality of rewards;
receiving, by a client application of the UE, a selection of the challenge and one of the rewards;
obtaining, by the client application, verification data used to prove completion of the challenge in response to receiving the selection of the challenge and the one of the rewards, wherein the verification data comprises at least one of Global Positioning System (GPS) data, pictures, videos, smart watch data, connected device data, user data, or social media data;
transmitting, by the client application, the verification data to the server to verify completion of the challenge;
receiving, by the server, feedback data including other challenge data for other challenges similar to the challenge and other reward data corresponding to the other challenge data, each for users other than the user;
retraining, by the server, a machine learning mode based on the feedback data to form a retrained machine learning model;
determining, by a verification application of the server using the retrained machine learning model, a confidence score of the verification data, wherein the confidence score represents a likelihood that the user successfully completed the challenge, wherein determining the confidence score by processing the verification data with the retrained machine learning model improves accuracy of the determination of the confidence score in comparison to processing the verification data with the machine learning model; and
transmitting, by a reward application of the server, a code to the UE to claim the one of the rewards in response to the confidence score exceeding a threshold value.

15. The method of claim 14, wherein the challenge indicates one or more tasks that are to be completed by the user to claim the one of the rewards, and wherein the rewards comprise a coupon, a monetary reward, free or discounted services from a business enterprise, or free or discounted products from a business enterprise.

16. The method of claim 14, further comprising generating, by the challenge application, the options message based on user data stored in a data store communicatively coupled to the server, wherein the user data comprises at least one of past challenges completed by the user, past rewards received by the user, general user information, current and prior location data of the user, social media history of the user, prior recorded hobbies, or prior recorded skills.

17. The method of claim 14, further comprising:
transmitting, by the client application of the UE to the reward application of the server, a request for a customized reward;
transmitting, by the reward application, the request for the customized reward to an enterprise server associated with a business enterprise offering the challenge to verify whether the business enterprise approved the customized reward;
receiving, by the reward application from the enterprise server, an indication as to whether the business enterprise approved the customized reward;
transmitting, by the reward application of the server to the client application of the UE, an accept customized reward message indicating that the customized reward has been approved by the business enterprise; and
transmitting, by the reward application of the server to the client application of the UE, a reject customized reward message indicating that the customized reward has been rejected by the business enterprise.

18. The method of claim 14, wherein the verification data comprises a plurality of different types of data, wherein the determining, by the verification application of the server using the machine learning model, the confidence score of the verification data comprises determining a different confidence score for each of the different types of data using the trained machine learning model, wherein the confidence score is based on an average of the different confidence scores for each of the different types of data.

19. The method of claim 14, wherein the machine learning model comprises a facial recognition algorithm, and wherein the machine learning model is trained using other verification data from other users that completed a similar challenge.

20. The method of claim 14, further comprising receiving, by a witness application of the server, a message from a witness UE comprising witness verification data further verifying that the user is progressing toward or successfully completed the challenge, wherein the data comprises at least one of a text message, a picture, a video, or GPS data.
